(19) United States
(12) Patent Application Publication
(10) Pub. No.: US 2007/0184183 A1
(43) Pub. Date: Aug. 9, 2007

(54) Dipping process for a long-term anti-smudge coating

(76) Inventors: Jau-Jier Chu, Hsin-Chu (TW); Jyh-An Chen, Hsin-Chu (TW); Jung-Chi Chen, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/348,271

(22) Filed: Feb. 7, 2006

(51) Int. Cl. C03C 17/00; B05D 1/18

(52) U.S. Cl. 427/163.1; 427/430.1

(57) ABSTRACT

A dipping process for a long-term anti-smudge coating is disclosed. The dipping process includes the steps of: fixing a plurality of polarizers onto a dipping frame; moving a solution tank of a dipping apparatus upwardly to the dipping frame for passively dipping the polarizers in the solution tank with long-term anti-smudge solutions; moving the solution tank down for passively separating the polarizers from the solution tank; coating the long-term anti-smudge solutions comprising medicinal solutes and solvents on the polarizers to form a solution films; and processing the solution films by fixing the polarizers onto a fixing board under a constant temperature and constant humidity.

### BACKGROUND OF THE INVENTION

1. Field of the Invention

The present invention relates to a dipping process for a long-term anti-smudge coating, and particularly relates to a dipping process adapted to polarizers that are usually used in the monitor industry for applying a long-term anti-smudge coating on polarizers.

2. Description of the Related Art

In the monitor industry, especially in regard to LCD (Liquid Crystal Display) devices, polarizers are key components. In general, both an inner polarizer and an outer polarizer adjust the brightness of a monitor device. Because the outer polarizer contacts with the external environment, the external surface of the polarizer needs to be coated with an anti-smudge coating thereon to reduce the possibility of dirtying the surface of the polarizer during the monitor device's assembly process, and to decrease the surface energy for moving the dust from the polarizers easily.

Anti-smudge coating is usually formed on a polarizer by a dipping, plating, spin coating or evaporation method, and the plating method is usually adapted to a ordinary micron film, but it cannot be adapted to a finer optical film. The spin coating method is most suited to small areas or rigid substrates. With regard to the evaporation deposition, it needs expensive vacuum equipment, and the evaporability of the coating materials and the thermostability of the substrates need to be considered. Hence, users need to consider both the cost of the required equipment and the convenience of the process of the evaporation deposition.

Furthermore, referring to T.W. patent 460391 and other prior art, fluorocarbon resin has a low surface energy in prior art. Hence, it is a suitable choice for the fluorocarbon resin to be coating solutes. However, the following problems are encountered when matching fluorocarbon resins with solvents:
(1) When matching fluorocarbons resins with non-fluorocarbon series solvents to form solutions with low solubility and repulsion, the uniformity of the coating on the polarizers will be affected;
(2) When matching fluorocarbons resins with alcohol solvents to form solution, both the water absorption and the water content of the solution (fluorocarbons resins+alcohol solvents) reduces the using life of the solution
(3) When matching fluorocarbons resins with fluorocarbon series solvents to form solution, catalysts must be added to the solution, shorten the using life of solution.

Additionally, because the polarizers are thin and light when they are actively moved into the solution tank during the dipping process, they can be easily waved. Hence, under this kind of unstable process the poor quality and high defect products are obtained.

### SUMMARY OF THE INVENTION

The present invention provides a dipping process for applying a long-term anti-smudge coating on polarizers. The present invention can achieves an excellent anti-smudge disposition by improving the coating equipment, adjusting the solution and controlling the conditions of the dipping process. Hence, the excellent long-term anti-smudge coating of the present invention is helpful for follow-up monitor's manufacture.

Moreover, when the polarizers are dipped, the polarizers are not easily waved. Furthermore, after the polarizers are withdrawn from the solution tank, the solution reacts on the polarizer forming a coat. This dipping process occurs best at a constant temperature and at a constant humidity, and does not require the use of any catalysts. Hence, the using life of the solution is extended and the costs of productions are reduced.

One aspect of the invention is a dipping process for a long-term anti-smudge coating, comprising the steps of: fixing a plurality of polarizers onto a dipping frame; moving a solution tank of a dipping apparatus upwardly to the dipping frame for the polarizers being dipped passively into the solution tank. The polarizers are passively separated from the solution tank by moving the tank down, and the long-term anti-smudge solution comprising medicinal solutes and solvents are coated on the polarizers. The solution films are cured by fixing the polarizers onto a fixing board under a constant temperature and constant humidity.

Another aspect of the invention is a dipping process for a long-term anti-smudge coating, comprising the steps of: fixing a plurality of polarizers onto a clamping board; moving a solution tank of a dipping apparatus upwardly to the clamping board for the polarizers being dipped passively into the solution tank. The polarizers are passively separated from the solution tank by moving the tank down, and the long-term anti-smudge solution comprising medicinal solutes and solvents are coated on the polarizers. The solution films are cured by fixing the polarizers onto a clamping board under a constant temperature and constant humidity.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a flowchart of a dipping process for a long-term anti-smudge coating in accordance with the first embodiment of the present invention; and

FIG. 2 is a flowchart of a dipping process for a long-term anti-smudge coating in accordance with the second embodiment of the present invention.

### DETAILED DESCRIPTION OF PREFERRED EMBODIMENTS

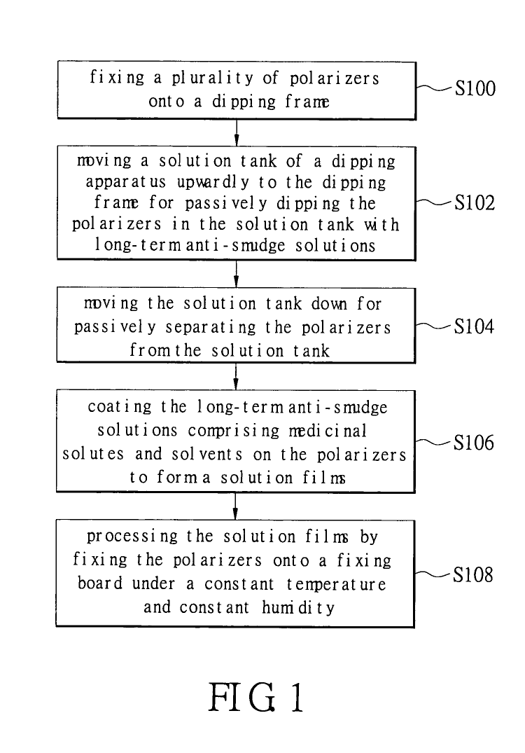

FIG. 1 shows a flowchart of a dipping process for a long-term anti-smudge coating in accordance with the first embodiment of the present invention. The present invention provides a dipping process for a long-term anti-smudge coating. The dipping process includes the following steps: fixing a plurality of polarizers onto a dipping frame (S100), wherein the polarizer can be a sheet polarizer, and each of the polarizers has four edges fixed onto the dipping frame; moving a solution tank of a dipping apparatus upwardly to the dipping frame for passively dipping the polarizers in the solution tank with long-term anti-smudge solutions (S102), wherein the medicinal solutes can be fluorocarbon resins, and have a low surface energy, the solvent is a fluorocarbon solvent with a low boiling point (lower than 70° C.), and is used to dilute the medicinal solutes; moving the solution tank down for passively separating the polarizers from the solution tank (S104); coating the long-term anti-smudge solutions comprising medicinal solutes and solvents on the polarizers to form a solution films (S106); processing the solution films by fixing the polarizers onto a fixing board under a constant temperature and constant humidity (S108), wherein the four edges of each of the polarizers are fixed onto the fixing board, and the processing step is used to accelerate the long-term anti-smudge solutions coated on the polarizers for obtaining an anti-reflection and long-term anti-smudge effect.

Furthermore, the processing step can be accelerated via a curing method using a temperature of between 40° C. and 70° C. and a relative humidity of between 30% and 70%. Alternatively, the processing step can be a standing method under a room temperature.

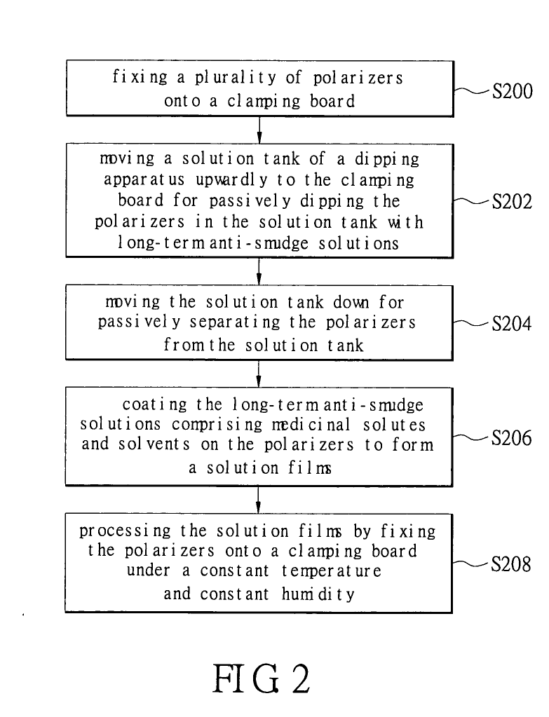

FIG. 2 shows a flowchart of a dipping process for a long-term anti-smudge coating in accordance with the second embodiment of the present invention. The present invention provides a dipping process for a long-term anti-smudge coating. The dipping process includes the following steps: fixing a plurality of polarizers onto a clamping board (S200), wherein the polarizer can be a sheet polarizer, and each of the polarizers has four edges fixed onto the clamping board, the clamping board can be an aluminum board; moving a solution tank of a dipping apparatus upwardly to the clamping board for passively dipping the polarizers in the solution tank with long-term anti-smudge solutions (S202), wherein the medicinal solutes can be fluorocarbon resins, and have a low surface energy, the solvent is a fluorocarbon solvent with a low boiling point (lower than 70° C.), and is used to dilute the medicinal solutes; moving the solution tank down for passively separating the polarizers from the solution tank (S204); coating the long-term anti-smudge solutions comprising medicinal solutes and solvents on the polarizers to form a solution films (S206); processing the solution films by fixing the polarizers onto a clamping board under a constant temperature and constant humidity (S208), wherein the processing step is used to accelerate the long-term anti-smudge solutions coated on the polarizers for obtaining an anti-reflection and long-term anti-smudge effect.

Furthermore, the processing step can be accelerated via a curing method using a temperature of between 40° C. and 70° C. and a relative humidity of between 30% and 70%. Alternatively, the processing step can be a standing method under a room temperature.

In conclusion, when the polarizers are dipped, the polarizers are not easily waved. Furthermore, after the polarizers are withdrawn from the solution tank, the solution reacts on the polarizer forming a coat. This dipping process occurs best at a constant temperature and at a constant humidity, and does not require the use of any catalysts. Hence, the user life of the solution is extended and the costs of productions are reduced.

Moreover, the present invention uses passive way to execute dipping process for solving the instability that when the polarizers are actively moved into the solution tank during the dipping process. Furthermore, processing (curing or standing) the solution films that are coated on the polarizers after the dipping of polarizers. Hence, the long-term anti-smudge solutions can be used repeatedly without affecting the quality of the solution.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A dipping process for a long-term anti-smudge coating, comprising the steps of:
fixing a plurality of polarizers onto a dipping frame;
moving a solution tank of a dipping apparatus upwardly to the dipping frame for passively dipping the polarizers in the solution tank with long-term anti-smudge solutions; moving the solution tank down for passively separating the polarizers from the solution tank;
coating the long-term anti-smudge solutions comprising medicinal solutes and solvents on the polarizers to form a solution films; and
processing the solution films by fixing the polarizers onto a fixing board under a constant temperature and constant humidity.

2. The dipping process as claimed in claim 1, wherein the polarizers are sheet polarizers.

3. The dipping process as claimed in claim 1, wherein each of the polarizers has four edges fixed onto the dipping frame or the fixing board.

4. The dipping process as claimed in claim 1, wherein the medicinal solutes have a low surface energy between 15 and 18 dyne/cm.

5. The dipping process as claimed in claim 1, wherein the medicinal solutes are fluorocarbon resins.

6. The dipping process as claimed in claim 1, wherein the solvents are fluorocarbon solvents with a boiling point lower than 70° C.

7. The dipping process as claimed in claim 1, wherein the processing step is used to accelerate the long-term anti-smudge solutions coated on the polarizers for obtaining an anti-reflection and long-term anti-smudge effect.

8. The dipping process as claimed in claim 1, wherein the processing step is a curing method.

9. The dipping process as claimed in claim 8, wherein the curing method is executed in a temperature of between 40° C. and 70° C., and a relative humidity of between 30% and 70%.

10. The dipping process as claimed in claim 1, wherein the processing step is a standing method under a room temperature.

11. The dipping process as claimed in claim 1, wherein the solvents are used to dilute the medicinal solutes.

12. A dipping process for a long-term anti-smudge coating, comprising the steps of:
fixing a plurality of polarizers onto a clamping board;
moving a solution tank of a dipping apparatus upwardly to the clamping board for passively dipping the polarizers in the solution tank with long-term anti-smudge solutions;
moving the solution tank down for passively separating the polarizers from the solution tank;
coating the long-term anti-smudge solutions comprising medicinal solutes and solvents on the polarizers to form a solution films; and
processing the solution films by fixing the polarizers onto a clamping board under a constant temperature and constant humidity.

13. The dipping process as claimed in claim 12, wherein the polarizers are sheet polarizers.

14. The dipping process as claimed in claim 12, wherein the clamping board is an aluminum board.

15. The dipping process as claimed in claim 12, wherein the medicinal solutes have a low surface energy between 15 and 18 dyne/cm.

16. The dipping process as claimed in claim 12, wherein the medicinal solutes are fluorocarbon resins.

17. The dipping process as claimed in claim 12, wherein the solvent is a fluorocarbon solvent with a boiling point lower than 70° C.

18. The dipping process as claimed in claim 12, wherein the processing step is used to accelerate the long-term anti-smudge solutions coated on the polarizers for obtaining an anti-reflection and long-term anti-smudge effect.

19. The dipping process as claimed in claim 12, wherein the processing step is a curing method.

20. The dipping process as claimed in claim 19, wherein the curing method is executed in a temperature of between 40° C. and 70° C., and a relative humidity of between 30% and 70%.

21. The dipping process as claimed in claim 12, wherein the processing step is a standing method under a room temperature.

22. The dipping process as claimed in claim 12, wherein the solvents are used to dilute the medicinal solutes.
